(19) United States
(12) Patent Application Publication
(10) Pub. No.: US 2002/0188452 A1
(43) Pub. Date: Dec. 12, 2002

(54) Automatic normal report system

(76) Inventor: Simon L. Howes, Monroe, CT (US)

Correspondence Address: WELSH & FLAXMAN LLC, 2341 JEFFERSON DAVIS HIGHWAY, SUITE 112, ARLINGTON, VA, 22202, US

(21) Appl. No.: 09/877,254

(22) Filed: Jun. 11, 2001

(51) Int. Cl. G10L 21/00

(52) U.S. Cl. 704/270

(57) ABSTRACT

The invention relates to a dictation/transcription management system allowing users to retrieve normal reports in lieu of actually dictating the report. The system includes at least one input receiving instructions from a user, a normal report storage system storing at least one master normal report, a processor permitting the user to dictate a new message or select the at least one master normal report and a reporting system transmitting the selected materials for subsequent processing. The invention further relates a method for implementing the dictation/transcription management system.

### BACKGROUND OF THE INVENTION

1. Field of the Invention

The invention relates to a dictation/transcription management system. More particularly, the invention relates to a dictation/transcription management system including a database of normal reports allowing users to retrieve normal reports in lieu of actually dictating the report.

2. Description of the Prior Art

Automated document preparation systems have been available for some time. These systems allow a plurality of individuals to dictate information to a transcription center where the dictated information is stored, transcribed and processed for distribution in accordance with a predetermined arrangement.

Such systems are commonly employed in the healthcare industry where physicians, nurses and other medical professionals are required to maintain detailed records relating to the status of the many patients they see during the course of their daily routine. With this in mind, the present specification is written with reference to the healthcare industry where specific examples are considered necessary for understanding the present invention. However, those skilled in the art will appreciate the far-reaching applications contemplated to be within the spirit of the present invention.

With reference to FIG. 1, a dictation/transcription system 10 currently offered by the assignee of the present invention is disclosed. The system 10 employs a variety of input devices 12a, 12b, 12c through which an individual may dictate information to the system 10. Such input devices may include, for example, a PC 12a, conventional voice based telephone transmissions 12b or wireless/mobile input devices 12c. In fact, a wide variety of input devices may be used so long as the input device provides the required information to the remainder of the system in a format understood by the system.

The information coming from the input device 12a, 12b, 12c is stored in an input collection device 14 where the information is prepared for subsequent transcription. Specifically, a voice workflow server 16, which interprets the dictated information to determine its priority and special instructions relating to the dictated information, categorizes the information. For example, the voice workflow server 16 may determine that further related information is available, and should be included in the file. As such, the voice workflow server 16 is integrated with a radiology information system 18 capable of integrating radiological information with the information dictated by the individual.

The compiled information is then integrated with patient information via, for example, the admission discharge transfer database 20 of the medical center. This compiled information is then forwarded to the document creation server 22 where a transcriptionist transcribes it in a predetermined manner.

The compiled and fully transcribed document is then forwarded to a document distribution engine 24 which transmits the transcribed document, as well as any related information, to previously designated recipients.

While currently available systems offer customers substantial convenience in the preparation of documents, the current systems require substantial investment on the part of healthcare facilities and other businesses which might choose to implement the system. Specifically, the system described above is designed for use by a single healthcare facility. The healthcare facility must, therefore, purchase, install, and maintain the hardware and software necessary to operate the dictation/transcription system. The healthcare facility must further train and update those individuals responsible for maintaining and operating the system. This represents a major investment in both time and money for an operation whose primary focus is the treatment of patients. As such, a continuing need exists for a more automated, convenient and operator friendly dictation/transcription system.

As with virtually all industries, the healthcare industry in particular is beset by a need for readily available information. From physicians to patients the ready availability of information is somewhat limited when one looks to the availability of information in other fields. While much of the known scientific information relating to medicine is available via public and/or private databases, the manner in which the data is gathered and analyzed is very similar to methods which have been utilized since the development of the printing press.

That is, physicians conduct research on an individual basis and publish reports telling of the information they have found through their research. The basis for their research is, however, usually information of which they have first hand knowledge or information which has been previously published by other physicians.

In addition to the limited availability of information for use by physicians, the available information regarding the practice of medicine is stored and prepared in an arcane manner not readily understandable by the conventional patient. As such, medical patients are often forced to rely entirely upon information given to them by their personal physicians, and consequently overlook alternate procedures which may be preferable to those suggested by their personal physician.

In addition to the preparation of dictated reports, the current health care system is overwhelmed by the inefficiency associated with the required preparation of standard reports dictated and transcribed over and over in the preparation of medical reports relating to common ailments or negative test results.

For example, women over 50, and sometimes over 40, are encouraged to have yearly mammograms performed in an effort to ensure the early detection of breast cancer. The vast majority of these mammograms reveal no cancer and no need for further testing. Each one of the negative mammograms, however, requires the preparation of a medical report documenting the results of the test. These reports are generally standard, but current health care systems still require that attending physicians dictate a complete report and the dictated report be transcribed by a typist at a transcription center (or the medical facility where the physician is in practice).

The dictation and transcription of these “normal” reports is highly time consuming for both the physician and transcriptionist when one considers the vast number of “normal” reports which are prepared on a daily basis. A need, therefore, exists to reduce the redundancy associated with the preparation of these “normal” reports. The present invention provides a system for substantially reducing the time and effort associated with the preparation of normal reports.

### SUMMARY OF THE INVENTION

It is, therefore, an object of the present invention to provide a dictation/transcription management system allowing users to retrieve normal reports in lieu of actually dictating the report. The system includes at least one input receiving instructions from a user, a normal report storage system storing at least one master normal report, a processor permitting the user to dictate a new message or select the at least one master normal report and a reporting system transmitting the selected materials for subsequent processing.

It is also an object of the present invention to provide a dictation/transcription management system wherein a plurality of normal reports are stored in the normal report storage system.

It is another object of the present invention to provide a dictation/transcription management system including means for inputting the at least one master normal report by a user.

It is a further object of the present invention to provide a dictation/transcription management system including means for inputting the at least one master normal report during the set-up of the system.

It is also another object of the present invention to provide a dictation/transcription management system including means for inputting the at least one master normal report subsequent to the set-up of the system.

It is yet a further object of the present invention to provide a dictation/transcription management system including means for inputting the at least one master normal report as a canned set by a health care organization.

It is still another object of the present invention to provide a dictation/transcription management system wherein subsequent processing includes combining the master normal report with a header, patient information, and CC information to create a complete report.

It is also an object of the present invention to provide a dictation/transcription management system wherein the complete report is forward to the user for review.

It is a further object of the present invention to provide a dictation/transcription management system wherein the processing further includes document distribution.

It is yet another object of the present invention to provide a dictation/transcription management method achieved by storing at least one master normal report for subsequent processing, receiving instructions from a user as to whether the user wishes to dictate a new message or retrieve a master normal report previously dictated by the user, retrieving a master normal report previously dictated by the user where the user instructs the system to do such or recording a new message dictated by the user when the user chooses to dictate a new message and transmitting either the master normal report selected by the user or the new message dictated by the user for subsequent processing.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of a prior dictation/transcription system.

FIG. 2 is a schematic of the information system in accordance with the present invention.

FIG. 3 is a detailed schematic of the public subscriber server.

FIG. 4 is a flow chart of information and/or document processing in accordance with the present invention.

FIG. 5 is a schematic of the information system in accordance with the present invention.

FIG. 6 is a detailed schematic of the public subscriber server in accordance with the embodiment disclosed in FIG. 5.

FIG. 7 is a detailed schematic of the normal report storage system.

FIG. 8 is an example of a compiled report.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

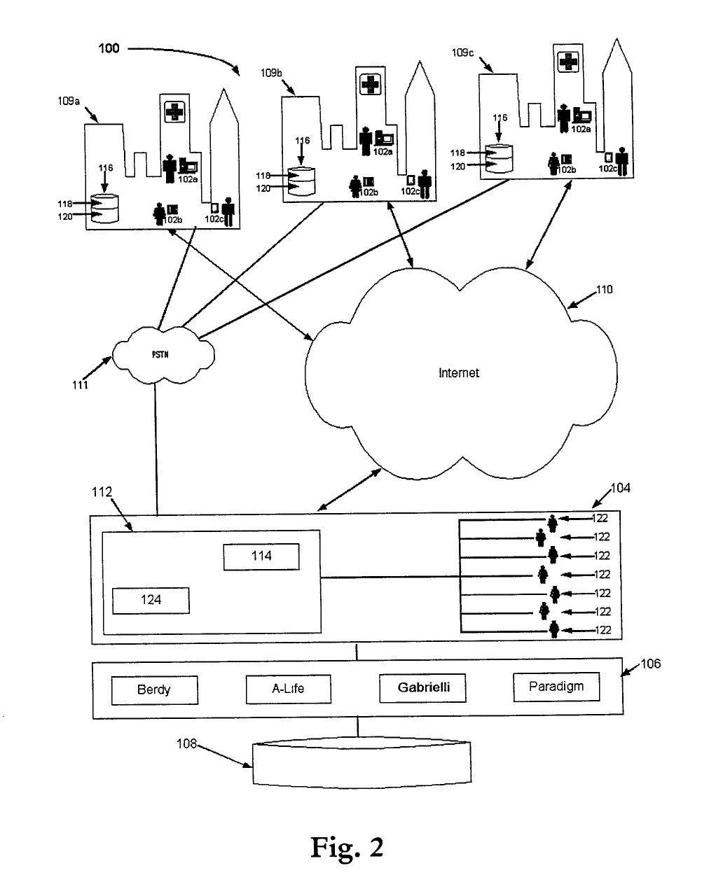

With reference to FIG. 2, an information processing system 100 in accordance with the present invention is disclosed. The information processing system 100 includes at least one user input device 102a, 102b, 102c transmitting voice, data and/or text files, a transcription center 104 at which voice, data and/or text files received from the at least one user input device are processed for transcription to produce reports in predefined formats, a natural language processing system 106 applying knowledge-based analysis for processing and compiling the reports, and a dynamic experiential database 108 processing the information gleaned from the reports to add value to the incoming information. In accordance with a preferred embodiment of the present invention, a plurality of user input devices 102a, 102b, 102c associated with a plurality of distinct subscribers 109a, 109b, 109c are linked with a public subscriber server 112 associated with the transcription center 104.

The present disclosure refers to voice, data and text files which are utilized by the transcription center 104 in the creation of predefined reports. As used herein these terms are employed in their broadest sense and should not be considered to limit the information which may be processed in accordance with the present invention. Specifically, a voice file is considered to refer to verbal instructions intended to be transcribed into text files at the transcription center 104. A data file is considered to be instructions associated with the voice file for identifying the appropriate report format, hospital information, patient information, physician information, etc.

Data files may be created in a variety of ways, including, but not limited to, speech recognition of voice commands intimately associated with the voice files or direct data input via a keypad associated with the input device. In accordance with a preferred embodiment of the present invention, and in accordance with common practice in the healthcare industry, it is contemplated that the data files will likely be created via speech recognition of voice commands intimately associated with the voice files. Text files are a human-readable sequence of characters and the words they form that can be encoded into computer-readable formats, such as ASCII. Text is usually distinguished from non-character encoded data, such as voice files in the form of bitmaps and program code.

The present invention uses a variety of input devices which are generally conventional in nature. For example, dictation may be input to the transcription center 104 via a physical workstation 102a, a telephone communication device 102b or a mobile/wireless communication device 102c. Each of these input devices allows for the direct transmission of required voice and data files for later transcription at the transcription center 104. In addition, the physical workstation also allows for the transmission of text files which may be processed in conjunction with the voice and data files to create the desired predetermined reports. While these three input devices are disclosed for use in accordance with a preferred embodiment of the present invention, other input devices, or combinations thereof, may be employed without departing from the spirit of the present invention.

In accordance with a preferred embodiment of the present invention, Dictaphone Inc. offers an array of user input devices which may be implemented in accordance with the present invention. For example, devices similar to Dictaphone's Boomerang® Enterprise Edition and Walkabout™ Express may be implemented in accordance with the present invention.

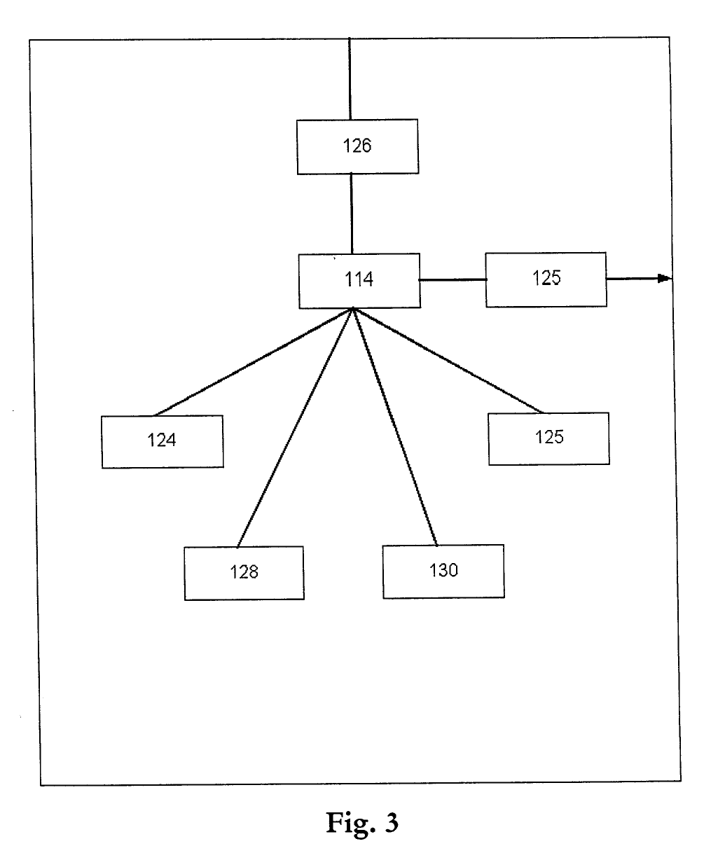

With reference to FIGS. 2 and 3, voice, data and text files input via any of the input devices are first transmitted to a public subscriber server 112 located at the transcription center 104. While the public subscriber server 112 in accordance with a preferred embodiment of the present invention is located at the transcription center 104, those skilled in the art will readily understand that the public subscriber server 112 need not be physically located at the same location as the other components of the transcription center 104 but may be located remote from the other components of the transcription center 104 and linked therewith via a local area network, wide area network, or other network.

In addition, the public subscriber server is referred to as being singular throughout the body of the present specification. However, those skilled in the art will readily appreciate that the public subscriber server described in accordance with the present invention may take various forms, including development based upon a plurality of linked servers, without departing from the spirit of the present invention.

Transmission between the input devices 102a, 102b, 102c and the public subscriber server 112 is preferably performed via the Internet 110 or conventional telephone landlines 111. Where the Internet 110 is utilized, the voice files are preferably transmitted using Voice Over IP (VoIP). VoIP is a term used in IP telephony for a set of facilities for managing the delivery of voice information using the Internet Protocol (IP). In general, this means sending voice information in digital form in discrete packets rather than in the traditional circuit-committed protocols of the public switched telephone network (PSTN). A major advantage of VoIP and Internet telephony is that it avoids the tolls charged by ordinary telephone service. In addition to IP, VoIP uses the real-time protocol (RTP) to help ensure that packets get delivered in a timely way.

The public subscriber server 112 is therefore provided with a “VoIP device” (such as Cisco's AS5300 access server with the VoIP feature) at its gateway. The gateway receives the packetized voice files transmitted from user input devices and then routes them to other parts of its network (local area or wide area network) or, using a T-1 or E-1 interface, sends them over the public switched telephone network.

Where the Internet 110 is utilized, the data and text files are transmitted using TCP/IP (Transmission Control Protocol/Internet Protocol). TCP/IP is currently the basic communication language or protocol of the Internet. TCP/IP is a two-layered program. The higher layer, Transmission Control Protocol, manages the assembling of a message or file into smaller packets that are transmitted over the Internet and received by a TCP layer that reassembles the packets into the original message. The lower layer, Internet Protocol, handles the address part of each packet so that it gets to the right destination. Each gateway computer on the network checks this address to see where to forward the message. Even though some packets from the same message are routed differently than others, they'll be reassembled at the destination.

The public subscriber server 112 of the present invention is adapted for use by a plurality of unrelated subscribers. By providing a subscription based transcription system in accordance with the present invention, subscribers are relieved of the burden of maintaining their own dictation/transcription system and may, therefore, concentrate upon their actual business. As such, it is contemplated that the present system 100 will hold special appeal to smaller clinics and group practices which may not be able to justify the acquisition of a dedicated system as discussed above in the “Background of the Invention”. In addition, the receipt of voice, data and text files from a wide variety of subscribers facilitates the collection and maintenance of the information necessary to create the dynamic experiential database 108 discussed below in substantial detail.

Once properly routed from the user input device 102a, 102b, 102c, the voice, data and text files are stored within the public subscriber server 112 awaiting further processing. The public subscriber server 112 includes an enterprise commander 114 which coordinates the further processing of the transmitted files. This enterprise commander 114 is controlled through the adaptation of a system similar to Dictaphone's Enterprise Express. Generally, Enterprise Express is an enterprise-wide medical records workflow management system. Enterprise Express is built on Microsoft Windows NT Server and SQL Server technology, and supports all standard communication protocols. Enterprise Express consists of a suite of software applications that enable physicians and medical records departments, as well as other facilities requiring document processing, to efficiently create and process voice narrative into electronic records.

Specifically, the enterprise commander 114 provides control over the scheduling and routing of the voice files for transcription; reporting and accounting functions; adding, modifying and deleting users; and configuring and monitoring the system. The enterprise commander 114 may add users to the system and provide such users with various options. The enterprise commander 114 may modify these options and users may be removed from the system. Inquiries and reports on users are available to enterprise commander 114.

The enterprise commander 114 also has the capability to configure the system to meet local requirements. For example, voice ports may be configured to accept proprietary devices or PBX connections. The system parameters such as reserve voice capacity, cost factors, and alarm conditions may be set as needed. Statistics including date and time, Voice File utilization, estimated turn around time, and other performance measures are available via the enterprise commander 114.

Despite using a public network such as the Internet, the present system 100 provides the strongest authentication process available to prevent unauthorized people from unlawfully logging into the public subscriber server via the Internet or intercepting data transmissions. A 128-bit SSL digital encryption certificate by RSA (Rivest-Shamir-Adleman) resides on the authentication module 126 at the entry point to the public subscriber server 112. These digital certificates are electronic files that validate an individual's identity. When a user logs into the public subscriber server 112, before any information is transferred, the digital certificates software on the user's input device 102a, 102b, 102c sends an encrypted session to the authentication module 126 of the public subscriber server 112. If the user's identity cannot be validated, entry is denied. If the user's identity is validated, the authentication module 126 sends a public key to the user interface device 102a, 102b, 102c.

All transmissions from the point of validation until the end of the session are encrypted with triple-DES algorithms, the highest level of encryption recognized by the National Security Agency. In order to decrypt each transmission, the authentication module 126 uses a proper key that is unique to the log-in session.

In addition to ensuring the security the present system 100, the public subscriber server provides a dedicated backup module 128 for effectively safeguarding critical data; 24 hours a day-7 days a week. The backup module 128 offers full management of the data backup process. As part of the backup process, database servers 130 maintained at the public subscriber server 112 and linked with the backup module 128 are backed up on a regular basis. New information is backed up every night and all information is backed up every week within the public subscriber server 112. For added safety, all files are backed up to an alternate location every two weeks.

The public subscriber server 112 also provides for dictation, or voice file, recovery. The recovery software module 132 provides the ability to recover dictation to prevent data loss. For example, as a physician dictates, voice files are continuously recorded on a local hard drive (not shown) maintained on the user input device 102a, 102b, 102c. If, for instance, the physician is interrupted midstream or navigates off of the page, the PC fails or the Internet connection is lost, the work won't be lost. The voice files are automatically recovered from the local hard drive. When the recording is finished, the encrypted voice files are sent to the public subscriber server 112 and removed from the local hard drive.

The network utilized in implementing the present system 100 is highly reliable and provides optimum performance. It is contemplated that an Exodus network is used in accordance with a preferred embodiment of the present invention, although a variety networks may be used without departing from the spirit of the present invention.

The public subscriber server 112 also acts to retrieve information, for example, forms, patient information, hospital information etc. for inclusion with the report to be dictated. The public subscriber server 112 is instructed to retrieve specific information necessary for the completion of predetermined reports based upon information found in the data files previously discussed. Where the data files are in the form of voice instructions, the voice instructions are first converted to data files using speech recognition software. The converted data files are then applied by the public subscriber server 112 in retrieving appropriate information. In the case of a system used in the healthcare field, information from the hospital based database 116 is accessed by the public subscriber server 112 to facilitate management of the server database and the transcription of the voice files corresponding to dictation jobs representing various medical reports. For example, the public subscriber server 112 may retrieve patient, hospital and physician information from a hospital information system 118 maintained locally at the hospital. In addition, the public subscriber server 112 may retrieve radiology and other diagnostic information from a radiology information system 120 maintained locally at the hospital.

In use, upon the receipt of voice, data and/or text files from the user input device 102a, 102b, 102c, the public subscriber server 112 accesses the hospital database 116 to update the patient records to reflect the present status of the dictation jobs and corresponding medical report. Where the present system 100 is implemented with the use of actual transcriptionists 122, assignment of the transmitted instructions to a transcriptionist 122 is recorded by the public subscriber server 112 and the hospital database 116 is updated with the relevant information such that the hospital database 116 is consistently updated as to the status and content of the report submitted to the present system 100 for transcription.

As mentioned above, and upon receipt of the transmitted instructions, data files associated with the voice file are interpreted to identify relevant information which must be retrieved from the hospital database 116. Based upon the information identified in the attached data files, the public subscriber server 112 retrieves the appropriate patient and physician data (e.g. patient name and social security number, etc., physician name and ID number, etc.) for the particular report type as also identified in the data files accompanying the voice file requiring transcription.

Once the voice file is ready for transcription, either via speech recognition as is discussed below in substantial detail or by an actual transcriptionist, the public subscriber server 112 merges the patient and physician data with the identified report type (also identified by the data files). These report types are maintained at the public subscriber server 112.

In view of the subscribers' choice of having the voice file transcribed either by speech recognition software or an actual transcriptionist, the present system 100 offers subscribers either draft document processing or complete document processing. Draft document processing offers cost efficient and rapid Adraft report processing. The voice files are simply converted to text over a secure Internet connection using sophisticated continuous speech recognition engines maintained at the public subscriber server 112. The speech recognition module 124 is discussed below in substantial detail. The resulting draft is then returned electronically to the subscribers' medical record department (or any other selected location) for editing and distribution. This option offers subscribers a flexible and cost effective alternative to traditional transcription methods.

In contrast to the options offered via draft document processing, the system 100 is also capable of offering complete document processing. Specifically, complete document processing offers a complete outsourcing document transcription service for subscribers who choose to have their dictation not only transcribed (by either speech recognition software or an actual transcriptionist), but also edited, formatted and returned completed.

Once the information necessary for the completion of the dictated report is fully retrieved, the public subscriber server 112 forwards the voice file for transcription. In accordance with a preferred embodiment of the present invention, the transcription is achieved through the application of speech recognition software. The speech recognition software uses various algorithms to convert the digital voice files stored at the public subscriber server 112 into text files which may be subsequently reviewed by the individual presenting the document processing request, or a transcriptionist responsible for the review of documents produced via the application of the speech recognition software.

Where the voice file is to be transcribed through the use of speech recognition software, the voice file is processed by a speech recognition module 124 programmed with software adapted to transcribe the voice file to a text file. As mentioned above, and prior to transcription by the speech recognition software, the public subscriber server 112 interprets the data file to identify the required report form to be used in accordance with the specific transcription. The previously retrieved patient and physician data is then merged with the appropriate form and transcription moves forward. Where the public subscriber server 112 identifies the need for additional information for the completion of the designated form, the open architecture offered by the present system 100 permits the public subscriber server 112 to readily access a variety of information sources for the retrieval of the required information.

Transcription is then performed. It is contemplated that a variety of speech recognition software may be employed in accordance with the present invention. For example, systems are currently available from Lernout & Hauspie, Philips and Dragon Systems. Regardless of the system used in accordance with the present invention, the voice or data files will be applied to determine the appropriate language model for placing the dictated materials in their proper context. For example, the terminology and context use by radiologists is different from that used by surgeons. The speech recognition software will note this difference to better transcribe the voice files applied thereto.

Where an actual transcriptionist 122 is transcribing the voice file, the public subscriber server 112 forwards the relevant voice file to the word processor of the transcriptionist 122. The word processor also receives the patient and physician data, as well as the identification of the report type. The word processor uses the received report type to retrieve information identifying the proper format for the identified report type from a file of report formats stored locally at the word processor or at the public subscriber server 112, and merges the patient and physician data with the identified format and displays the merged information. Thus, the initially displayed report form will include necessary information which is already in the system database; relieving the transcriptionist 122 of the need to transcribe that information, and the dictator of the need to originally provide it.

As can be seen from the above description, it is preferred that word processors store files of the formats for each report type to be processed in accordance with the present invention. However, it is also within the contemplation of the subject invention that the report formats could be maintained by the public subscriber server 112 and the merged information transmitted to the word processor, avoiding the need and expense of maintaining storage for these files at each work station.

The word processor would respond to sign-on by the transcriptionist 122 to update the job record and send it to the public subscriber server 112. The public subscriber server 112 would then update the patient records again to reflect the current status of the corresponding medical report. The dictation system then outputs the dictation job voice file to the selected one of workstations in a conventional manner for transcription. At this point, the transcriptionist 122 would transcribe the voice file into the displayed format in a conventional manner, using the word processor to create the text and transcription unit to access the voice file. The word processor loops through while the dictation system loops through until the transcriptionist 122 is satisfied that the voice file has been properly and accurately transcribed into the display format. At this time the transcriptionist 122 would sign-off and signal the public subscriber server 112 that transcription was completed through the word processor.

Whether the voice file is transcribed via speech recognition software or an actual transcriptionist 122, text files transmitted by the user input device 102a, 102b, 102c may be incorporated in the prepared report at any point in the transcription process.

In summary, the public subscriber server 112 acts to order the input request for transcription, assign appropriate transcriptionist and/or method for transcription, and coordinate the retrieval of information associated with each document processing request. The public subscriber server 112 functions listed above are neither meant to be limiting nor exhaustive of those functions performed by the public subscriber server in initiating and performing the transcription of documents in accordance with the present invention.

Where transcription is performed through the use of speech recognition software, the speech recognition software module 124 of the public subscriber server 112 transcribes the voice files to usable text files with only the need for the intervention of a transcriptionist to proof the document once the speech recognition module 124 has completed its transcription. As the technology associated with speech recognition software continues to improve, it is contemplated that the need for a transcriptionist to review the automatically transcribed document will cease to exist.

Once fully converted to text form, and placed on the proper form, the prepared report is used for various purposes. In accordance with conventional transcription services, the text file, formatted into a predetermined report form with appropriate information appended thereto, is distributed via a document distribution engine 125 to various locations in accordance with a predetermined system arranged by the subscriber. Distribution is highly automated in accordance with known technology and may include e-mail, facsimile, telephone notification or regular mail.

In accordance with the present invention, the prepared report, which is substantially composed of a text file, is forwarded to a natural language processor 106 to compile information which may be subsequently used to enhance document processing and information retrieval. More specifically, a natural language processor 106 link with a text normalization processor generally processes the report. The natural language processor 106 and text normalization processor act upon the report to compile relevant information necessary to those working in a specific field.

Briefly, the information directly compiled via the natural language processor 106 is used in providing for coding compliance, automatic report compilation, structuring of reports to provide information in a user-friendly format and treatment outcome information. For example, the natural language processor 106 allows the present system 100 to offer subscribers post report processing/coding services using natural language processing and knowledge based coding rule sets to analyze text and assign highly accurate ICD-9/CPT reimbursement codes, without the need for human involvement.

The system 100 will also provide web based electronic medical records services which organize freeform dictation transmitted in the form of voice files in the manner discussed above into a structured medical record accessibly over the Internet through a conventional browser based PC interface. Some of the many applications for this technology include: electronic clinical charting and patient documentation; physician report viewing and electronic signature capabilities; access to information by referring physicians; as well as review of valuable clinical information in a structured data format created by the present system's natural language processing technology. This service is also integrated with health information or data feeds for hospital information systems and/or practice management systems to make the process of creating patient charts more productive and accurate.

More specifically, various natural language processors working with text normalization processors are implemented to take full advantage of the information being generated via the present information processing system 100. In accordance with a preferred embodiment of the present invention, the transcribed reports are analyzed by Berdy SmartClinic and/or SmartVoice. These systems developed by Berdy Medical Systems allow for the conversion of medical data via voice recognition software and text normalization to readily provide physicians with useful information in a format immediately ready for use by the physician.

It is also contemplated that the present system 100 may use systems such as A-Life's LifeCode as an aid in proper coding. Specifically, diagnoses and procedures described in medical records are represented by values from a complex set of numerical codes established by the World Health Organization and the American Medical Association. These codes are used to submit claims for payment and to gather quantitative information about the patient encounter. They are critical since they are often the only way physicians and other providers communicate with those that pay for their services.

There are many thousands of both ICD-9 codes that represent diagnoses and CPT codes that represent procedures. LifeCode uses natural language processing to perform medical coding for billing purposes. Specifically, the LifeCode coding engine is capable of emulating how a human coder reads and codes medical records. The system extracts information from medical reports and automatically assigns all relevant codes and billing modifiers.

Other systems employing natural language processing to refine information generated via the transcription process include Gabrielli (manufactured by Computer Based Medicine, Inc.) for the extraction of relevant data and Paradym (manufactured by Paradigm Integration Inc.) for in-patient coding.

After compiling the relevant information from the reports generated via transcription, the data is fed to a dynamic experiential database 108 which processes the same to add value thereto. For example, and in the case of the present system 100 being used in the processing of medical information, vast quantities of medical information will be generated by the present system 100. As physicians, nurses and other medical personnel prepare reports via the present system 100, the dictated reports are prepared and the documents generated thereby are disbursed in accordance with the predetermined wishes of the subscriber. Beyond the mere generation of dictated documents, the present system 100 employs natural language processors in conjunction with a controlled medical vocabulary text normalization process to compile material information which may be subsequently utilized.

Specifically, much of the information generated in accordance with the dictation/transcription process disclosed above is processed via known natural language processor systems, for example, Berdy, A-Life, Gabrielli, Paradym, to generate defined information. Much of this defined information is immediately implemented in providing physicians with indexed reports, procedures automatically coded for transmission to insurance companies, etc.

The dynamic experiential database 108 of the present system 100 takes the compiled information generated by the natural language processors and stores the same for processing to create value-added information. As used herein the term “value-added” information relates to information developed from multiple sources such that the resulting information provides a benefit not provided by a single source only.

It is contemplated that the value-added information may integrate specific related experiences which would have otherwise gone unnoticed. For example, when physicians seek advice regarding the handling of matter, they generally seek out advice from local physicians with whom they have a professional relationship. As such, physicians are somewhat isolated from many of their colleagues. The present dynamic experiential database 108 allows physicians to combine their experiences with those of their remotely located colleagues living across the country or in another country.

The present experiential database 108 compiles the experiences of medical professionals from around the country or world to provide a comprehensive collection of information which may be readily accessed and utilized by healthcare professionals without the need for studying a series of conflicting publications to determine a proper course of action. For example, the experiential database 108 will compile the experiences of thousands of physicians in treating sore throats with high fever to suggest a variety of courses of action with annotations regarding their upside and downside.

The dynamic experiential database also provides physicians with procedural advice based upon the stored experiences of other practitioners. For example, where a physician isolates a variety of symptoms, the dynamic experiential database might present the physician with alternate diagnoses to consider.

Similarly, the present experiential database 108 will be open to the public, therefore, allowing patients to readily research illnesses for alternate treatments not suggested by their physicians. The information provided by the experiential database 108 stands in stark contrast to the information available by researching medical treatises and publications which often add more confusion in a patient's attempt to identify alternate modes of treatment.

By unlocking all the valuable information currently trapped in paper records, the experiential database 108 enables intelligent, confidential use of clinical patient information. Currently, medical records provide unprocessed, raw information. The present system 100 places that information at the physician's fingertips. Using natural language processing in conjunction with the present dynamic experiential database 108, the present system 100 transforms electronic text into normalized medical terminology and discrete data for analysis by physicians, hospitals or third parties. The result is the present system's unprecedented capability to aggregate anonymous data from diverse healthcare organizations to provide a rich database for clinical analysis. Practical applications include, but are not limited to, automatic coding, chronic disease analysis, quality reporting, and physician/hospital decision support.

With the forgoing in mind, the present system 100 offers physicians and hospital organizations, as well as other organizations requiring information processing, more control over the information which they create. The present system 100 offers physicians and healthcare organizations increased control over both the cost and the process of creating, managing and analyzing patient medical records. The present system 100 accomplishes this goal by providing a series of online services for medical records production and analysis, based upon previously unknown integration of Internet, voice, and natural language technologies. The system 100 may generally be thought of as a suite of online services for medical record production and analysis. These services automate the process of creating and managing patient medical records. As a result, subscribers can reduce the inefficiencies of creating patient reports while more effectively utilizing the clinical information contained within those reports.

It is contemplated that the present system 100 will transform healthcare information management by lowering costs with reduced inefficiencies, enabling access to clinical knowledge for analysis, and helping to relieve the market pressures to increase and improve documentation. The present system 100 was built on the premise that the current two-way Internet exchange of voice, text, data and knowledge will have a profound and long-term effect on the creation, management, and distribution of patient information.

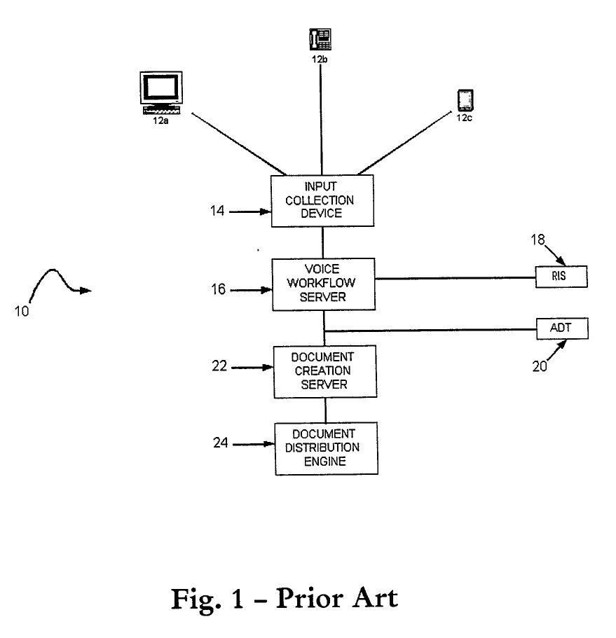

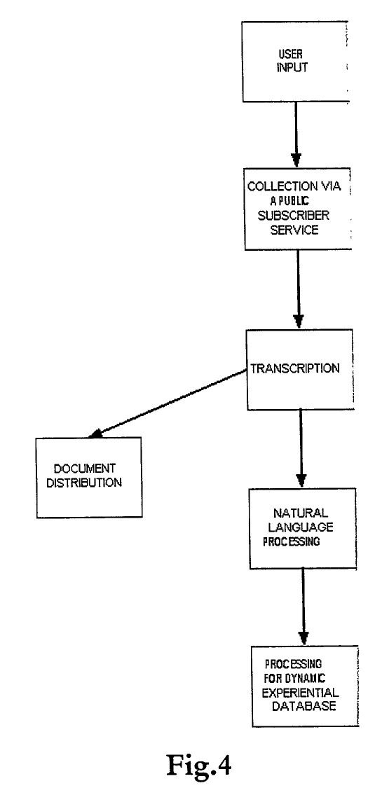

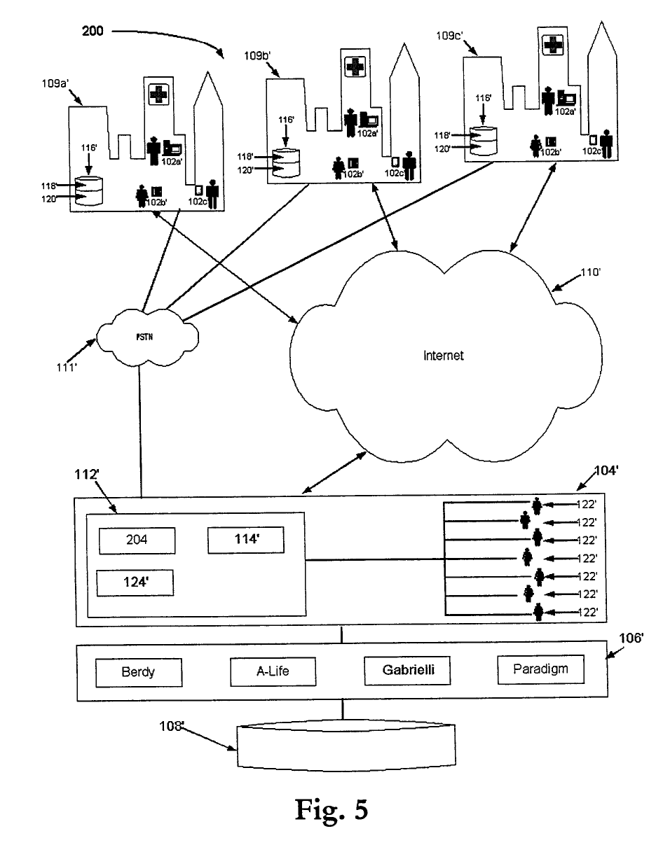

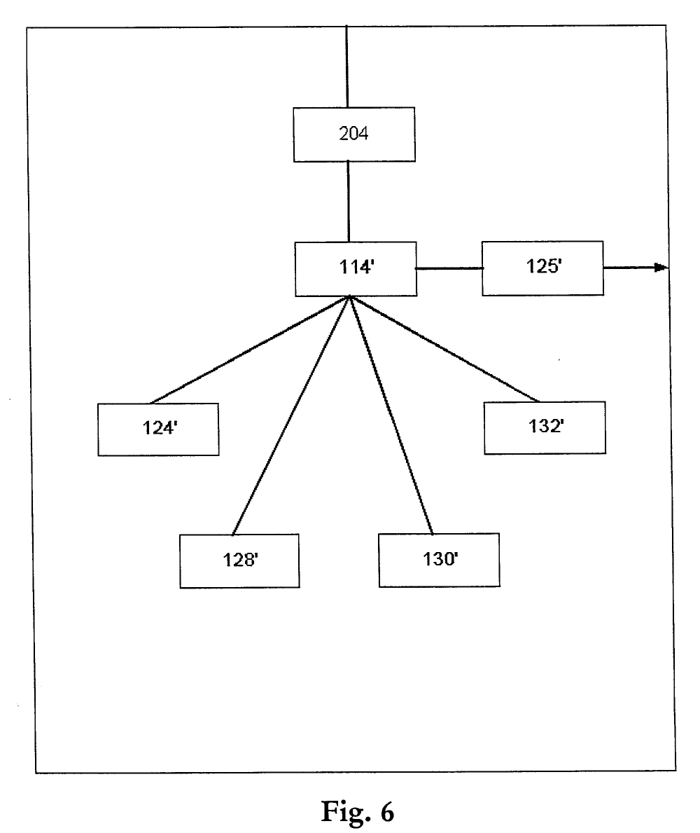

With reference to FIGS. 5 to 8, an alternate embodiment of the present dictation/transcription management system 202 is disclosed. The disclosed embodiment facilitates the creation of normal reports and may be implemented via the prior art system disclosed in FIG. 1 or the new system disclosed in FIGS. 2 to 4. The present dictation/transcription management system 202 is described below as implemented with the new system disclosed in FIGS. 2 to 4, although those skilled in the art will readily understand the manner in which the dictation/transcription management system 202 would be implemented with the prior art system.

This alternate embodiment is substantially the same as the system described above with reference to FIGS. 2 to 4, but incorporates a normal report storage system 204 allowing each user to maintain a database of master normal reports commonly encountered in his or her daily routine. The inclusion of a normal report storage system 204 permitting the storage of a plurality of master normal reports allows users to retrieve normal reports in lieu of actually dictating the report. This addition to the dictation/transcription management system 202 greatly enhances the overall efficiency associated with the required reporting of symptoms, diagnosis and other facts relating to the health of patients.

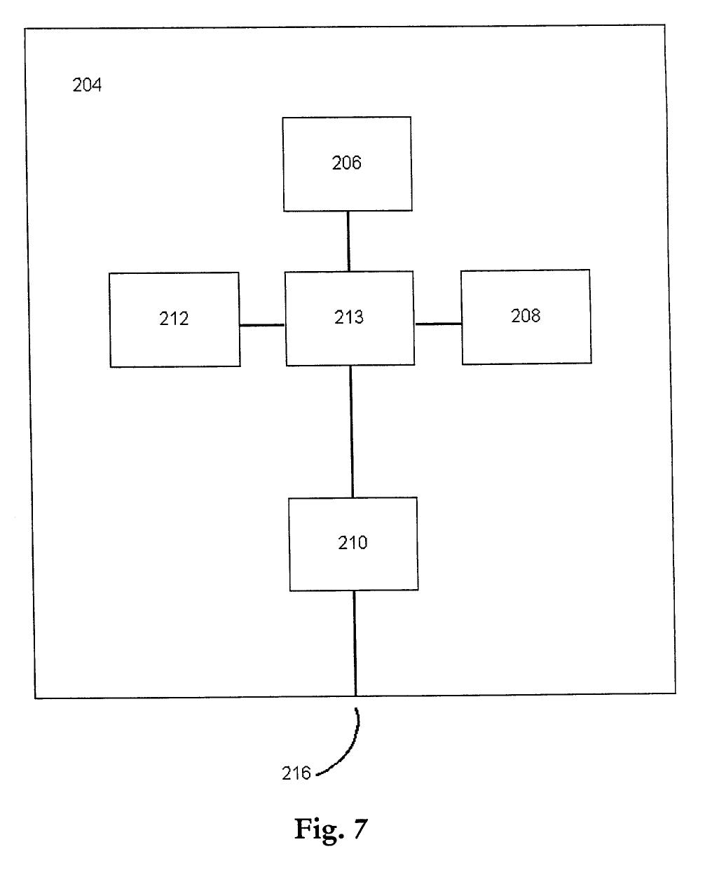

With reference to FIGS. 5, 6 and 7, the dictation/transcription management system 202 provides automatic normal reports by including the normal report storage system 204 in addition to those components previously discussed. Referring to FIG. 7, the normal report storage system 202 generally includes at last one input 206 receiving instructions from a user, a normal report selection processor 208 permitting the user to dictate a new message or select the at least one master normal report, and a reporting system 210 transmitting the selected materials for subsequent processing. The present system 202 maintains the conveniences of previously existing dictation/transcription systems, while incorporating the ability to store previously transcribed master normal reports for subsequent processing. The present system 202 also allows the author to indicate a master normal report for inclusion in a report without actually dictating the report at the time of the diagnosis.

Each of the previously recorded and transcribed master normal reports may be recalled at appropriate times in the future. Each master normal report is a read only template stored in both voice and text formats. The author specifies the type of master normal report using conventional barcode, keyboard or continuous speech recognition controls.

While the present dictation/transcription management system 202 is described below with reference to its application in the healthcare industry, it is contemplated, and should be readily understood by those skilled in the art, that the techniques employed in the present dictation/transcription management system 202 may be readily applied in a variety of fields without departing from the spirit of the present invention.

With this in mind, the present dictation/transcription management system 202 utilizes a variety of input devices 102a′, 102b′, 102c′ through which an individual may provide information to the system. Such input devices may include, for example, a physical workstation 102a′, a telephone communication device 102b′ or a mobile/wireless communication device 102c′. Each of these input devices allows for the direct transmission of required voice and data files for later processing. In addition, the physical workstation 102a′ allows for the transmission of text files that may be processed in conjunction with the voice and data files to create desired predetermined reports. While these three input devices are disclosed for use in accordance with a preferred embodiment of the present invention, other input devices, or combinations thereof, may be employed without departing from the spirit of the present invention. In accordance with a preferred embodiment of the present invention, Dictaphone Corporation offers an array of user input devices that may be implemented in accordance with the present invention. For example, devices similar to Dictaphone's Boomerang® Enterprise Edition and Walkabout™ Express may be implemented in accordance with the present invention.

The information coming from the input device 102a′, 102b′, 102c′ is processed by the normal report storage system 204 where the information is prepared for subsequent processing; for example, incorporation into reports for final review and signature. With this in mind, and in accordance with a preferred embodiment of the present invention, the normal report storage system 204 includes a database 212 in which master normal reports are stored, a processor 213 controlling operations of the normal report storage system 204, an input 206, an output 216 and other hardware components known to be used in the development of automated communication devices.

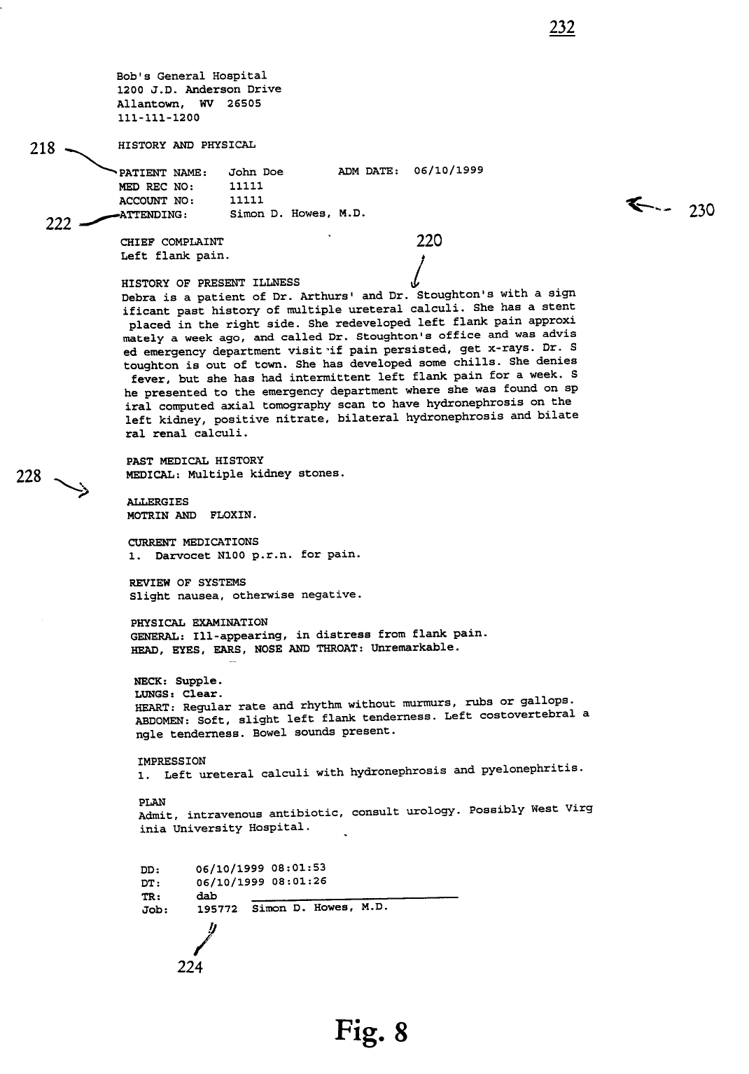

Specifically, upon the initiation of a dictation session, the user is required to enter information relating to the project being dictated. This may include, but is not limited to, information concerning the patient 218, the physician 220, other attending medical practitioners 222, distribution lists 224, etc. (see FIG. 8). As is well known to those skilled in the art, the input of such information may be achieved through the use of direct verbal instructions, keyboard instructions or the scanning of bar codes via a scanning device integrally associated with the input device 102a′, 102b′, 102c′.

Upon receipt of this information, or in conjunction with the input of this information, the user is prompted as to whether he or she wishes to dictate a new message or rely upon a previously dictated master normal report. If the user chooses to dictate a new message for transcription, or other processing, the user is prompted to dictate the information for transcription in a conventional manner. The information is then processed and passed onto the transcription center in a manner similar to those techniques applied in the prior art. As those skilled in the art will readily appreciate, a variety of systems are available for the transcription of general dictation and any may be used in accordance with the present system 102 while remaining within the spirit of the present invention.

If, however, the user wishes to rely upon a master normal report, the user accordingly instructs the system 202. For example, and in accordance with a preferred embodiment of the present invention, the user first instructs the normal report storage system 204, and specifically the normal report selection processor 208, of his or her intention to rely upon a previously stored master normal report. The exact required report is determined either by swiping a bar code with a barcode reader integrally associated with the input device 102a′, 102b′, 102c′, inputting a multi-digit code identifying the normal report which the user wishes to retrieve, or utilizing other standard techniques for instructing the normal report storage system 204 to retrieve the required information from the master normal report database 212 maintained by the normal report storage system 204. It is further contemplated that voice recognition software may be used for retrieving desired normal reports in accordance with the present invention.

A plurality of master normal reports are maintained in the master normal report database 212 of the normal report storage system 204. In accordance with a preferred embodiment of the present invention, the master normal reports are input in one of two manners. According to a first method for inputting the master normal reports, the user creates master normal reports. Specifically, the master normal reports are created when the user sets up the system 202 for his or her own personal use or the master normal reports are entered into the dictation/transcription management system 202 subsequent to the initial setup by simply instructing the normal report storage system 204 that the user wishes to add additional master normal reports to his or her database of reports. A transcriptionist 122′ then transcribes the dictated master normal reports and the text version is saved with the dictated version in the master normal report storage database 212 for subsequent retrieval and use. Similarly, the dictated master normal report may be transcribed by voice recognition systems currently known in the prior art. While these two methods are disclosed above for the transcription of the input normal reports, those skilled in the art will appreciate the variety of transcription systems that may be used in accordance with the present dictation/transcription management system 202 without departing from the spirit of the present invention.

In accordance with a second method for inputting the master normal reports, a canned set of master normal reports are installed upon the installation of the total dictation/transcription management system 202. It is contemplated that the hospital 109a′, 109b′, 109c′, or other health care organization, will develop the canned set of master normal reports to comply with their internal standards and requirements. As with the individual creation of master normal reports as discussed above, the canned normal reports are stored in the normal report database 214 of the normal report storage system 204 as both voice and text files such that a user may listen to a master normal report before choosing to designate the normal report for further processing. Where a canned set of normal reports is installed for use in accordance with the present system 202, the dictation/transcription management system 202 provides the user with the option of adding individual master normal reports in the manner discussed above. That is, and in addition to the canned set of master normal reports, individual master normal reports may be created as the user sets up the system or the master normal reports may be entered into the dictation/transcription management system 202 subsequent to the initial set-up by simply instructing the normal report storage system 204 that the user wishes to add addition master normal reports to the database 212 of reports.

When a user indicates a desire to utilize a master normal report, the normal report selection processor 208 of the normal report storage system 204 responds to the user's instructions by bypassing the anticipated recording step and proceeds to retrieve the identified master normal report. If desired, the normal report storage system 204 retrieves a previously recorded version of a specified master normal report as a voice file for listening purposes. The user may then review or edit the master normal report as he or she sees fit before registering the master normal report as a dictated report ready for subsequent processing. For example, the chosen master normal report may be reviewed, and edited, in text form before further processing or the user may add an addendum to the master normal report prior to registering the master normal report as a dictated report ready for subsequent processing.

The user may also skip the review step and immediately register the normal report as a dictated report in the system 202 for administration and reporting purposes. The user may also provide a control signal to an associated transcription system.

Whether the user inputs the master normal reports at set-up time, or subsequent thereto, the master normal reports are organized in a manner permitting ready retrieval when a user requires retrieval thereof. The reports may be organized and retrieved in a plurality of known ways, without departing from the spirit of the present invention. For example, and in accordance with a preferred embodiment of the present invention, retrieval is achieved by linking master normal reports based upon customer IDs and physician IDs. As such, when a physician logs on with his or her ID number, the physician is immediately provided with access to master normal reports defined in either the hospital's account of stored master normal reports or the physician's personal account of stored master normal reports.

Once the dictation/transcription management system 202 is instructed as to whether a new message is to be dictated or whether a master normal report is to be applied, the system 202 utilizes the reporting system 210 and the enterprise commander 114′ to forward the selected material for further processing. That is, where the materials are dictated in a conventional manner, the dictated voice file is transmitted to a transcription center for processing in a convention manner.

Where a normal report is chosen, the chosen normal report is combined with the information input at the initiation of the report and processed for review by the user. Specifically, the text file of the chosen master normal report 228 is combined with the header 230, patient information 218, and CC information, or distribution list, 224 to facilitate the automated preparation of a complete report 232 that is ready for review by the user. The reporting system 210 processes the body 228 (chosen normal report), header 230, patient information 218, and CC information 224 into a complete report 232 for further processing at a transcription center 122′. The reporting system 210 employs known dictation/transcription system components similar to those used in the previously discussed workflow server 16 (see “Background of the Invention”) to combine the information in a desired manner. As such, it is contemplated that a variety of processing techniques may be used to combine the body (chosen normal report) 228, header 230, patient information 218, and CC information 224 into a complete report 232 while remaining within the spirit of the present invention.

It is further contemplated that the body (chosen normal report) 228, header 230, patient information 218, and CC information 224 may be transmitted to a transcription center 122′ prior to being forwarded to the user. Specifically, the body (chosen normal report) 228, header 230, patient information 218, and CC information 224 would be transmitted to a transcription center 122′ in a combined format similar to that discussed above and a transcriptionist will review the combined format before forwarding the final report for signature by the user. Where the report is first forwarded to the transcription center 122′, the center will, 1) if desired, produce a text output of that particular normal without the requisite transcription component, 2) if desired, add the associated patient and medical demographics and 3) if desired, queue automatically the report for physician signature and approval.

Incorporated between the normal report storage system 204 and the transcription center 122′, is positioned an enterprise commander 114′ which coordinates the further processing of the transmitted files. As discussed above, the enterprise commander 114 is controlled through the adaptation of a system similar to Dictaphone's Enterprise Express. Generally, Enterprise Express is an enterprise-wide medical records workflow management system.

Once fully converted to text form, and placed on the proper format, the prepared report 232 is used for various purposes. In accordance with conventional transcription services, the text file, formatted into a predetermined report form with appropriate information appended thereto, is distributed via a document distribution engine to various locations in accordance with a predetermined system arranged by the subscriber. Distribution is highly automated in accordance with known technology and may include e-mail, facsimile, telephone notification or regular mail.

In use, the present system operates in the following manner. The user or health care organization first stores at least one master normal report for subsequent processing. As discussed above, a plurality of master normal reports relating to various situations and diagnosis are stored in the normal report storage system 204. Once the system 202 has at least one master normal report stored and ready for retrieval, the user may begin using the system 202 in accordance with the present invention.

Specifically, the user contacts the system 202 via an input device 102a′, 102b′, 102c′ and provides instructions. Each time the user contacts the system regarding a matter, he or she is prompted to indicate whether the user wishes to dictate a new message or retrieve a master normal report previously dictated by the user.

If the user wishes to retrieve a previously dictated master normal report, the user simply instructs the system 202, particularly, the normal report selection processor 208, as to his or her wishes and identifies the master normal report with which he or she wishes to work. If on the other hand, the user finds that the present situation does not warrant a master normal report, he or she simply instructs the system 202 of his or her intention to dictate a new message. Whether a previously recorder master normal report is chosen or a newly dictated message is chosen, the selected report is transmitted for subsequent processing.

Where a new report is dictated, the dictated report is transmitted to the transcription center for processing. Where, however, a normal report is chosen, the text file of the normal report is combined with the header, patient information, and CC information to facilitate the automated preparation of a complete report which is ready for review by the user. The processing of the body (chosen normal report) 228, header 230, patient information 218, and CC information 224 into a complete report is achieved using the reporting system 210.

Whether the report is prepared at a transcription center or via the automated normal reports of the present system 202, the report is returned to the user for final approval and signature. The report is the further processed by forwarding the same according to the CC list (i.e., document delivery), natural language processing, etc.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A dictation/transcription management system, comprising:
at least one input receiving instructions from a user;
a normal report storage system storing at least one master normal report;
means permitting the user to dictate a new message or select the at least one master normal report; and
a reporting system transmitting the selected materials for subsequent processing.

2. The dictation/transcription management system according claim 1, wherein a plurality of normal reports are stored in the normal report storage system.

3. The dictation/transcription management system according claim 1, further including means for inputting the at least one master normal report by a user.

4. The dictation/transcription management system according claim 3, further including means for inputting the at least one master normal report during the set-up of the system.

5. The dictation/transcription management system according claim 3, further including means for inputting the at least one master normal report subsequent to the set-up of the system.

6. The dictation/transcription management system according claim 1, further including means for inputting the at least one master normal report as a canned set by a health care organization.

7. The dictation/transcription management system according claim 1, wherein subsequent processing includes combining the master normal report with a header, patient information, and CC information to create a complete report.

8. The dictation/transcription management system according claim 7, wherein the complete report is forward to the user for review.

9. The dictation/transcription management system according claim 7, wherein the processing further includes document distribution.

10. A method for the management of a transcription/dictation system, comprising:
storing at least one master normal report for subsequent processing;
receiving instructions from a user as to whether the user wishes to dictate a new message or retrieve a master normal report previously dictated by the user;
retrieving a master normal report previously dictated by the user where the user instructs the system to do such or recording a new message dictated by the user when the user chooses to dictate a new message;
transmitting either the master normal report selected by the user or the new message dictated by the user for subsequent processing.

11. The method according claim 10, wherein a plurality of normal reports are stored in the normal report storage system.

12. The method according claim 10, wherein the step of storing includes inputting the at least one master normal report by a user.

13. The method according claim 12, wherein the at least one master normal report is input during the set-up of the system.

14. The method according claim 12, wherein the at least one master normal report is input subsequent to the set-up of the system.

15. The method according claim 10, wherein the step of storing includes inputting the at least one master normal report as a canned set by a health care organization.

16. The method according claim 10, wherein step of subsequent processing includes combining the master normal report with a header, patient information, and CC information to create a complete report.

17. The method according claim 16, further including the step of forwarding the complete report to the user for review.

18. The method according claim 16, further including the step of processing the complete report for document distribution.

19. A normal report storage system for use in conjunction with a dictation/transcription management system enabling a user to readily retrieve previously prepared master normal reports for subsequent processing, comprising:
at least one input receiving instructions from a user;
means for storing at least one master normal report;
means permitting the user to dictate a new message or select the at least one master normal report; and
a reporting system transmitting either the dictated message or the at least one master normal report for subsequent processing.

20. The normal report storage system according claim 19, wherein a plurality of normal reports are stored in the normal report storage system.

21. The normal report storage system according claim 19, further including means for inputting the at least one master normal report by a user.

22. The normal report storage system according claim 21, further including means for inputting the at least one master normal report during the set-up of the system.

23. The normal report storage system according claim 22, further including means for inputting the at least one master normal report subsequent to the set-up of the system.

24. The normal report storage system according claim 19, further including means for inputting the at least one master normal report as a canned set by a health care organization.

25. The normal report storage system according claim 19, wherein subsequent processing includes combining the master normal report with a header, patient information, and CC information to create a complete report.

26. The normal report storage system according claim 25, wherein the complete report is forward to the user for review.

27. The normal report storage system according claim 25, wherein the processing further includes document distribution.
